(19) United States
(12) Patent Application Publication
(10) Pub. No.: US 2010/0123332 A1
(43) Pub. Date: May 20, 2010

(54) Door to Cockpit Interface Apparatus for Use in a Vehicle

(75) Inventors: James Hotary, Holland, MI (US); Brian Dexter, Grand Haven, MI (US); Dan Vander Sluis, Rochester Hills, MI (US)

Correspondence Address: GIBSON & DERNIER LLP, 900 ROUTE 9 NORTH, SUITE 504, WOODBRIDGE, NJ, 07095, US

(73) Assignee: FAURECIA INTERIOR SYSTEMS U.S.A., INC., Auburn Hills, MI (US)

(21) Appl. No.: 12/619,821

(22) Filed: Nov. 17, 2009

Related U.S. Application Data
(60) Provisional application No. 61/115,317, filed on Nov. 17, 2008.

(51) Int. Cl. B60J 5/00

(52) U.S. Cl. 296/146.7

(57) ABSTRACT

A door to cockpit/Instrument Panel interface apparatus is provided with a skin layer disposed on and/or in the door and/or cockpit, and operates to create a line-to-line appearance or a seam, without gap, between door and cockpit through compression therebetween. The flexibly resilient skin layer possesses such resilience that when a driver or passenger opens the door, the compressed area of the skin layer disposed on and/or in the door (or the cockpit) springs back to its original configuration and/or shape. The interface apparatus may employ a resilient support along with the skin layer to provide the compressibility. The resilient support may include a foam layer, springs, a recess behind the skin layer, etc. The interface apparatus may reduce the cost(s) and weight/mass load(s) associated with manufacturing door to cockpit interfaces, and the apparatus may provide a unique aesthetic approach and structural freedom to designing a vehicle interior.

### CROSS-REFERENCE TO RELATED APPLICATIONS

This application claims the benefit of U.S. Provisional Patent Application No. 61/115,317, filed Nov. 17, 2008, the entirety of which is incorporated herein by reference.

### FIELD OF THE INVENTION

The present invention is directed to door to cockpit/Instrument Panel systems that employ flexibly resilient materials and/or skin layer(s) that creates a line-to-line fit by compressing between the door and the cockpit (also referred to as the “Instrument Panel” or the “IP”) in a vehicle, or the like. The present invention relates generally to a door to cockpit interface apparatus for use in automotive vehicles, and, more particularly, concerns an elastic or flexible door to cockpit interface apparatus which is part of the assembly of a door or a cockpit, and interacts with the door and the cockpit in a vehicle.

### BACKGROUND OF THE INVENTION

The door to cockpit/IP interface is always an area of perceived quality issues and challenges. Cross car tolerances vary from automaker to automaker, and platform to platform. As such, it is difficult to properly align the door to the cockpit interface while reducing and/or eliminating any gap(s) between the door and the cockpit. As such, a challenge exists to create an interface apparatus that provides gap consistency between automakers and platforms. The door to cockpit interface area is also useful for the aesthetic theme of a vehicle, and, therefore, of great importance to automakers.

As automakers are under considerable pressure to reduce vehicle manufacturing cost, mass, and size (while at the same time increasing gap consistency), interior components, such as the door to cockpit interface, need to be downsized and/or connected/integrated optimally.

It would therefore be desirable to provide a door to cockpit interface apparatus for use in a vehicle door or cockpit assembly to provide a unique aesthetic while also reducing the weight and cost associated with manufacturing a vehicle door to cockpit interface. There is also a need in the art for a door to cockpit interface apparatus to reduce and/or eliminate any gaps that may be located in between the door and the cockpit without the use of such an apparatus.

### SUMMARY OF THE INVENTION

In accordance with one or more embodiments of the present invention, a door to cockpit interface apparatus is provided with a compliant or flexibly resilient skin layer to provide a perceived or actual line-to-line fit between the door and cockpit/IP of the vehicle. When a driver and/or passenger pushes a door against the cockpit, the apparatus located within the door or cockpit may “temporarily deform” and become line-to-line with the cockpit. The line-to-line communication between the door and the cockpit may be such that any gaps between the door and the cockpit are minimized or eliminated. A vehicle may include a cockpit including at least one lateral side surface directed toward a door opening of the vehicle; a door disposed in hinged relationship with respect to the door opening; a trim panel coupled to the door and directed toward an interior of the vehicle when the door is in a closed position; and a door to cockpit interface apparatus located on at least a portion of the trim panel and operating to engage and compress against the lateral side surface of the cockpit when the door is in the closed position, such that a seam, without a gap, is formed between the portion of the trim panel and the lateral side surface of the cockpit. The interface apparatus may operate to substantially return to its original configuration when not compressed between the portion of the trim panel and the lateral side surface. The door to cockpit interface apparatus may be disposed on a cockpit/Instrument Panel (IP) or on a door of the vehicle, but preferably, the apparatus may be permanently integrated into a vehicle door. To provide a perceived or actual line-to-line fit between the door and the IP, the interface apparatus may include compliant or flexibly resilient material, such as but not limited to, fabric, vinyl, leather, suede, synthetics, or the like.

The vehicle may include a skin layer disposed on the trim panel and directed toward an interior of the vehicle, such that the skin layer engages and compress against the lateral side surface of the cockpit when the door is in the closed position; and at least one resilient support disposed under the skin layer and operating to provide compressibility of the skin layer opposite the lateral side surface of the cockpit. The at least one resilient support may be sized and shaped to correspond with a predetermined surface area of compression between the skin layer and the lateral side surface of the cockpit. The at least one resilient support may be sized and shaped larger than a predetermined surface area of compression between the skin layer and the lateral side surface of the cockpit, such that a portion of the at least one resilient support does not deform during compression when the door is closed. The at least one resilient support may include a foam layer beneath the skin layer, and/or may include additional resilient material, such as, but not limited to, foam, springs (e.g., coil-spring bedding or mattress), or the like. The thickness of the foam layer may be at least 6-8 mm. The skin layer may be formed from at least one of: cloth fabric, vinyl, leather, suede, and synthetics.

A carrier module may be coupled to the door and supporting the trim panel, such that the foam layer is sandwiched between the carrier module and the skin layer, wherein a thickness of the foam layer is sufficient to cause the skin layer to contact and engage a substantial portion of the lateral side surface of the cockpit when the door is closed. Compression of the foam layer may occur by way of the carrier module or trim panel on one side, and the lateral side surface of the cockpit on the other side.

At least one rigid element may be disposed over the skin layer and in engagement with at least one of the carrier module and the trim panel, such that the at least one rigid element presses the skin layer into the foam layer, and the skin layer remains taut in a region of the door to cockpit interface apparatus. At least one relief recess may be positioned within the lateral side surface of the cockpit, and sized and shaped to receive the at least one rigid element when the door is in the closed position.

Alternatively or additionally, the at least one resilient support may include at least one recess behind the skin layer, size and shaped such that the engagement of the lateral side surface of the cockpit against the skin layer causes the skin layer to press and stretch into the at least one recess. The vehicle may further include a carrier module coupled to the door and supporting the trim panel, wherein the at least one recess is formed within the carrier beneath the skin layer opposite the lateral side surface of the cockpit when the door is closed. The skin layer may be stretched over the trim panel; and the trim panel may include one or more apertures in registration with the at least one recess such that the skin layer is stretchable, and may be pressed, into the at least one recess.

At least one rigid element may be disposed over the skin layer and in engagement with at least one of the carrier module and the trim panel, such that the at least one rigid element presses the skin at least toward the carrier module, and the skin layer remains taut in a region of the door to cockpit interface apparatus. At least one relief recess may be positioned within the lateral side surface of the cockpit, and sized and shaped to receive the at least one rigid element when the door is in the closed position.

The vehicle may further include a first port through a portion of the skin layer and the at least one resilient support operating to transfer air therethrough; and a second port through a portion of the lateral side of the cockpit and in fluid communication with the first port when the door is closed, wherein the second port operates to transfer air from a source to the first port and the first port operates to transfer the air through the door. At least one rigid element may be disposed over the skin layer and in engagement with a rigid portion of the door, such that the at least one rigid element presses the skin at least toward the carrier module, and the skin layer remains taut in a region of the door to cockpit interface apparatus, wherein the first port extends through the at least one rigid element and through the portion of the skin layer and the at least one resilient support. One or more apertures may be in communication with the first port and may extend through the skin layer of the door such that the air transferred from the cockpit to the door via the first and second ports emits from the door to an interior of a vehicle. The one or more apertures may include at least one of: perforations, laser-etched holes, recesses, and vents.

The present invention of the instant application provides the advantage of creating an appearance of (or actual) line-to-line condition, without gap, on the door to cockpit/IP interface, higher perceived quality scores, higher cross car tolerances, and new ways/freedoms to express vehicle aesthetics, spaces, and themes. Aspects of the present invention may also allow for a lighter and cheaper door assembly.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown, but rather only by the claims. To assist those of ordinary skill in the relevant art in making and using the subject matter hereof, reference is made to the appended drawings and figures, wherein:

FIG. 1A is a perspective view of a door to cockpit interface apparatus disposed in a vehicle door with the door opened and not interfacing with the cockpit of the vehicle in accordance with at least one embodiment of the present invention.

FIG. 1B is a perspective view of a door to cockpit interface apparatus disposed in a vehicle door with the door interfacing with the cockpit of the vehicle in accordance with at least one embodiment of the present invention.

FIG. 2A is a cross-sectional view of the interface apparatus taken along lines 2A-2A of FIG. 1A having a flexibly resilient skin layer and a resilient support disposed on a vehicle door with the door in the open position in accordance with at least one embodiment of the present invention.

FIG. 2B is a cross-sectional view of the interface apparatus taken along line 2B-2B of FIG. 1B having a flexibly resilient skin layer and a resilient support with the vehicle door and the cockpit in a closed position in accordance with at least one embodiment of the present invention.

FIG. 3A is a cross-sectional view of an alternate embodiment of an interface apparatus taken along lines 2A-2A of FIG. 1A having a flexibly resilient skin layer and a resilient support including at least one recess positioned behind the skin layer disposed on a vehicle door with the door in the open position in accordance with at least one embodiment of the present invention.

FIG. 3B is a cross-sectional view of the alternate embodiment of an interface apparatus taken along line 2B-2B of FIG. 1B having a flexibly resilient skin layer and a resilient support including at least one recess positioned behind the skin layer disposed on a vehicle door with the door in the closed position in accordance with at least one embodiment of the present invention.

FIG. 4 is a side view of the interface apparatus disposed on a vehicle door, in accordance with at least one aspect of the present invention.

FIGS. 5A and 5B are side schematic views of alternate embodiments of the rigid member disposed on the apparatus in accordance with at least one aspect of the present invention.

FIG. 6A is a perspective view of a door to cockpit interface apparatus disposed in a vehicle door and having an air passage, with the door opened and not interfaced against the cockpit of the vehicle in accordance with at least one embodiment of the present invention.

FIG. 6B is a perspective view of a door to cockpit interface apparatus disposed in a vehicle door and having an airtight passage with the door interfacing with the cockpit of the vehicle, and where the door includes perforations in accordance with at least one embodiment of the present invention.

### DETAILED DESCRIPTION OF THE PRESENT INVENTION

A door to cockpit interface apparatus is disclosed herein for providing a lightweight, cost-effective, and aesthetically improved mechanism for allowing the door to interface with the cockpit in a vehicle. The interface apparatus is placed within the vehicle, such as in a door, cockpit/Instrument Panel, or the like, during manufacture, repairs, or an upgrade procedure. The interface apparatus includes a flexibly resilient skin layer that is disposed between the door and the cockpit, and the apparatus may either be located in and/or on the door or the cockpit. The apparatus may be employed in automobiles, planes, trains, trucks, buses, boats, helicopters, submersible vehicles, spacecraft, or the like. In particular, the present invention relates to a flexibly resilient door to cockpit interface apparatus that is located between a door and a cockpit of a vehicle to provide a perceived or actual line-to-line condition on the door to IP/cockpit interface, higher perceived quality scores, higher cross car tolerances, and new ways/freedoms to express vehicle aesthetics, spaces, and themes.

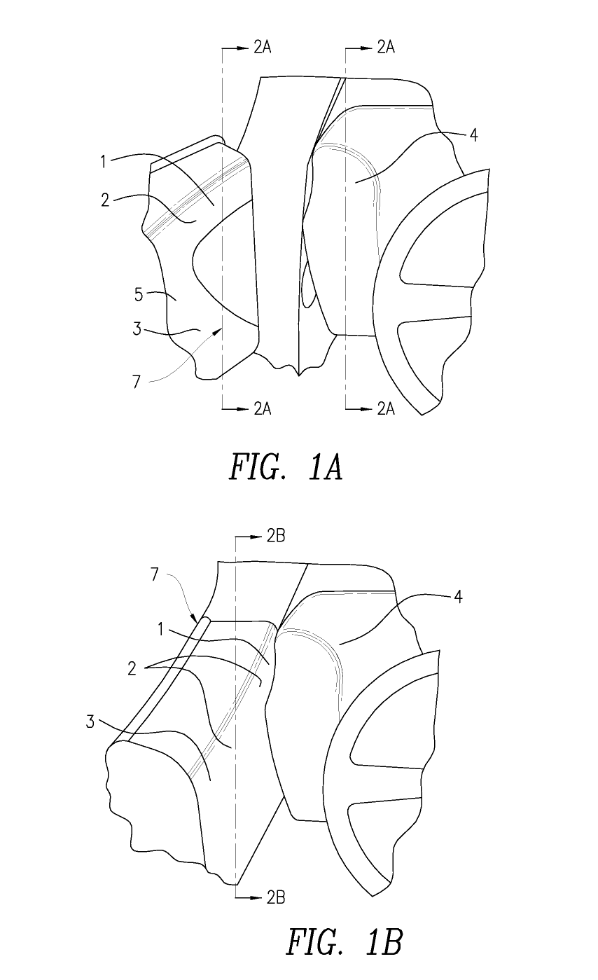

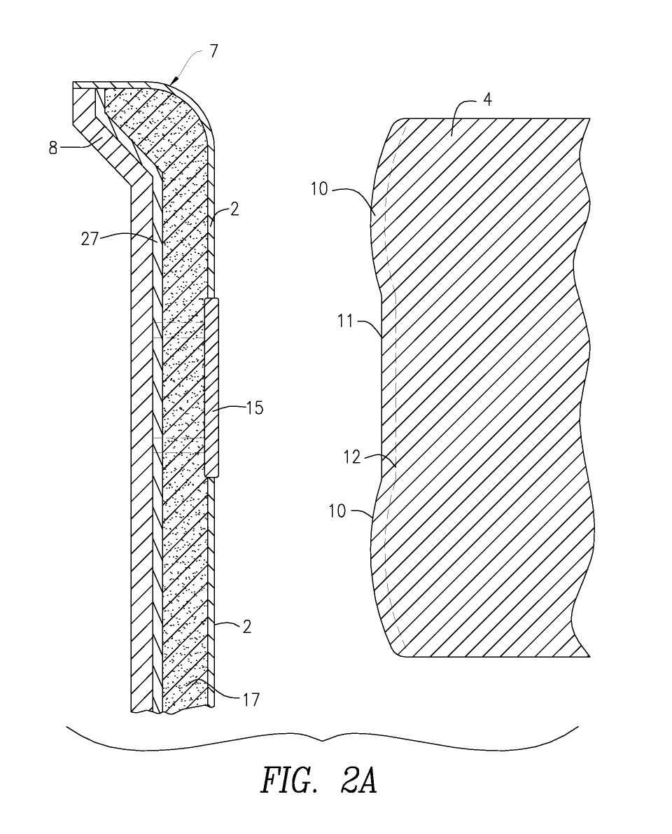

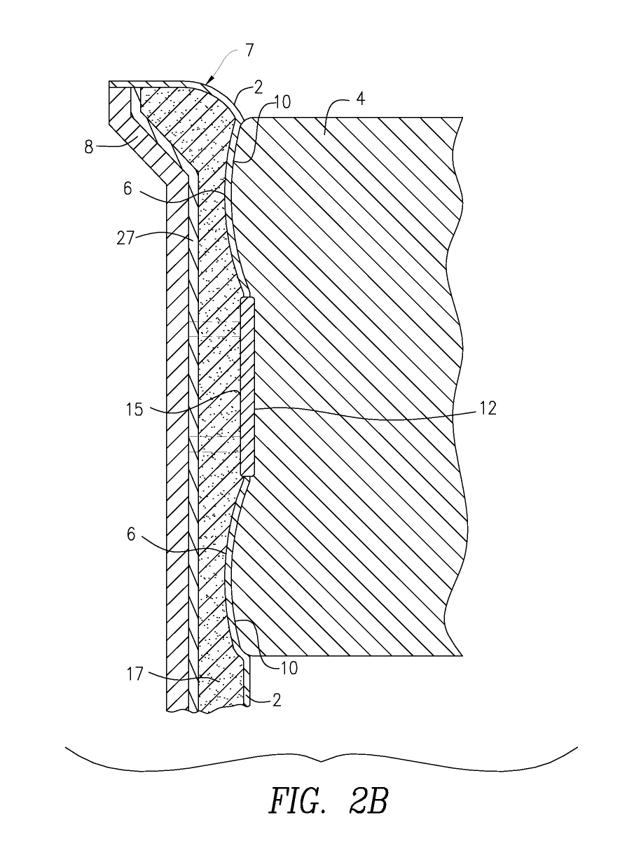

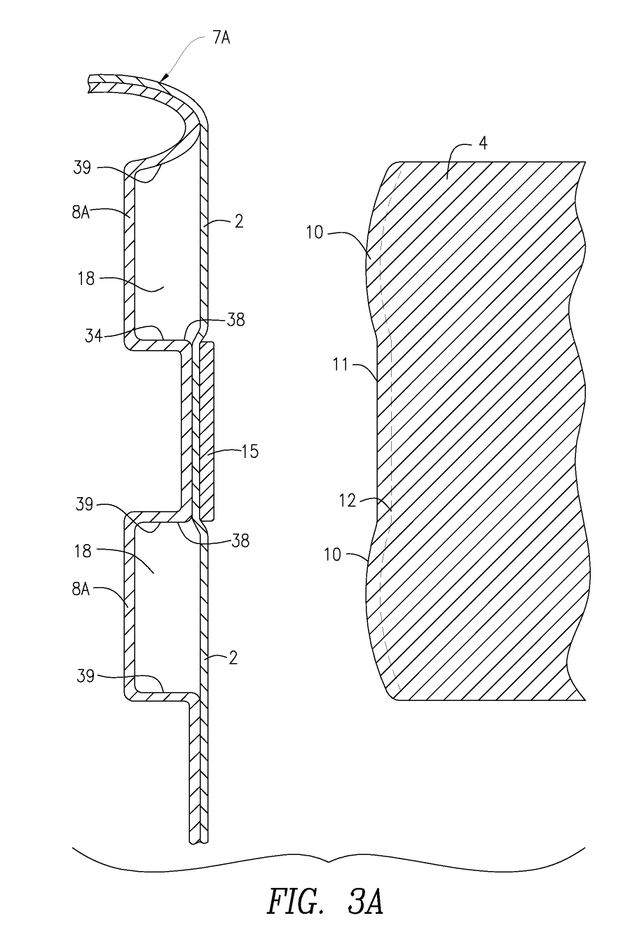

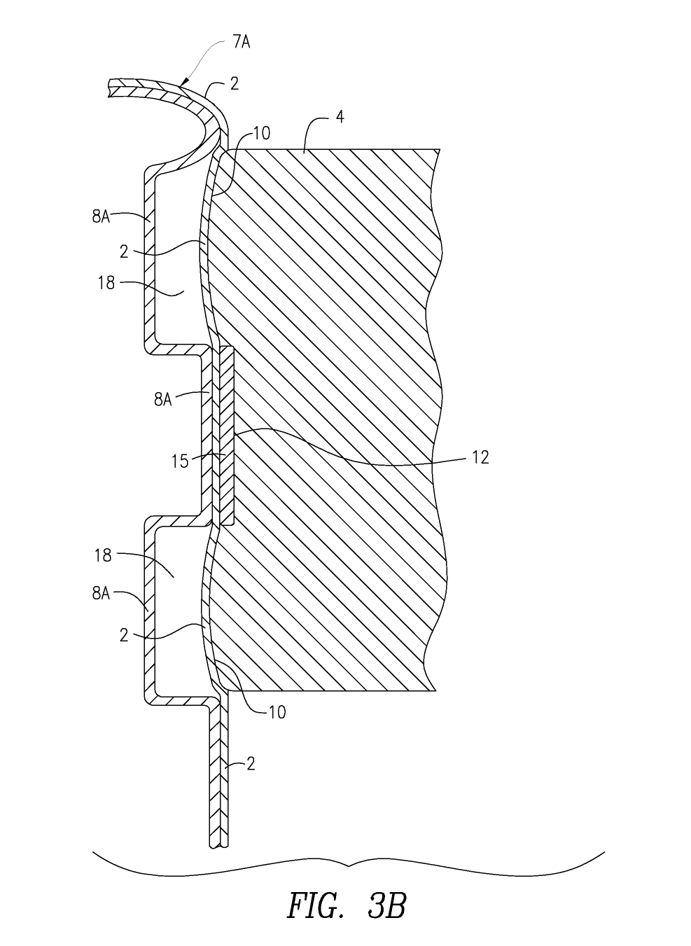

Turning now to the details of the drawings, FIGS. 1A-3B illustrate a vehicle including a door to cockpit interface apparatus 1. The vehicle may include a cockpit 4 including at least one lateral side surface 11 (as best seen in FIGS. 2A and 3A) directed toward a door opening of the vehicle; and a door 3 disposed in hinged relationship with respect to the door opening. A trim panel 7, 7A is coupled to the door 3 (as best seen in FIGS. 2A and 3A) and is directed toward an interior of the vehicle when the door 3 is in a closed position. A door to cockpit interface apparatus 1 is located on at least a portion of the trim panel 7, 7A and operates to engage and compress against the lateral side surface 11 of the cockpit 4 when the door 3 is in the closed position, such that a seam, without a gap, (as best seen in FIG. 1B) is formed between the portion of the trim panel 7, 7A and the lateral side surface 11 of the cockpit 4. The door to cockpit interface apparatus 1 may operate to substantially return to its original configuration when not compressed between the portion of the trim panel 7, 7A and the lateral side surface 11.

The interface apparatus 1 may be disposed on and/or in the trim panel 7, 7A of the vehicle door 3 (e.g., on and/or in a side/panel 5 of the door 3), but the interface apparatus 1 may also be disposed on and/or in other areas of a vehicle, such as, but not limited to, a vehicle cockpit/IP 4, a vehicle chassis, a carrier module 8, 8A (as best seen in FIGS. 2A-3B), or the like. The interface apparatus 1 may be attached to the door 3 and/or the cockpit 4 in accordance with methods known to those skilled in the art, such as, but not limited to, sewing, bonding/gluing, molding, pressing, etc. Preferably, the interface apparatus 1 is integrated permanently into the vehicle door 3. When installed on and/or in any of the aforementioned vehicle areas, the interface apparatus 1 may appear “disguised” such that the interface apparatus 1 aesthetically blends into the vehicle area, such as the door 3, the cockpit 4, etc. As such, the interface apparatus 1 may appear as an original component of that area, such as the door 3, as if the interface apparatus 1 was not added: after the manufacturing of the door 3, before or after installation of the door 3 onto the vehicle, during repairs, during upgrades, etc. Thus, aesthetic and structural freedom (e.g., simplicity of design) may be achieved when constructing/using the vehicle.

As illustrated in FIGS. 2A-3B, the interface apparatus 1 may include a skin layer 2 and at least one resilient support 17. In accordance with at least one embodiment of the invention as illustrated in FIGS. 2A-2B, the door to cockpit interface apparatus 1 may include: a skin layer 2 disposed on the trim panel 7 and directed toward an interior of the vehicle, such that the skin layer 2 engages and compresses against the lateral side surface 11 of the cockpit 4 when the door 3 is in the closed position; and at least one resilient support 17 disposed under the skin layer 2 and operating to provide compressibility of the skin layer 2 opposite the lateral side 11 surface of the cockpit 4. The at least one resilient support 17 may provide and/or improve/increase a resilience and compressibility of the interface apparatus 1. As such, the interface apparatus 1 may return to its original shape and/or configuration when the door 3 is not interfacing with the cockpit 4 or vice versa, such as when a driver and/or passenger opens the door 3 to get in or out of the vehicle. When a driver or passenger closes the door 3 such that the door 3 interfaces with the cockpit 4 (as best shown in FIGS. 1B and 2B), the skin layer 2 and/or the at least one resilient support 17 of the interface apparatus 1, which may be disposed on the door 3 (as illustrated in FIGS. 1A-2B), may “temporarily deform” or compress between the door 3 and the cockpit 4 such that the door 3 becomes line-to-line with the cockpit 4 (i.e., a seam is formed between the door 3 and the cockpit 4 such that no gap exists therebetween). The “temporary deformation” or compression effect of the skin layer 2 and/or the at least one resilient support 17 may reduce and/or eliminate any gaps between the interfaced door 3 and cockpit 4 that would otherwise exist between the door 3 and the cockpit 4 when not using the interface apparatus 1. The gaps may be indicative of any hole, recess, gap, or other space that may be created during a manufacturing process of the door 3 (or cockpit 4), during an upgrade, during a repair, etc. As such, the interface apparatus 1 may be added to various types of vehicles at any time to reduce and/or eliminate such gaps during compression.

The “temporary deformation” or compression effect is merely temporary while the door 3 remains interfaced with the cockpit 4 because the skin layer 2 and the at least one resilient support 17 of the interface apparatus 1 may be made from flexibly resilient material. As such, when a driver or passenger opens the door 3 such that the door 3 is not interfaced with the cockpit 4 as shown in FIG. 1A, the skin layer 2 and/or the at least one resilient support 17 may return to its original shape and/or configuration (as shown in FIGS. 1A and 2A) due to the resilience of the material selected for skin layer 2 and/or the at least one resilient support 17 of the interface apparatus 1. Indeed, the interface apparatus 1 may exhibit a spring-back effect as the interface apparatus 1 returns to its original configuration when a driver or passenger opens the door 3 away from the cockpit 4. For example, an original configuration of the apparatus 1 may occur when the skin layer 2 and the at least one resilient support 17 are substantially flat when not “temporarily deformed” (i.e., compressed) between the door 3 and the cockpit 4 (as illustrated in the cross-sectional view of FIG. 2A taken from line 2A-2A of FIG. 1A).

Further, when the interface apparatus 1 is integrated as a portion of the door 3 and/or the cockpit 4 (or another component of the vehicle), it may appear to a driver and/or passenger(s) of the vehicle that the door 3 and/or the cockpit 4 may be compressing (e.g., at least in part) between the door 3 and the cockpit 4 when interfaced. Alternatively, when the door and the cockpit 4 are not interfaced, it may appear to a driver and/or passenger(s) of the vehicle that the door 3 and/or the cockpit 4 are returning to its original configuration. Because the apparatus 1 may be integrated with the door 3 and/or the cockpit 4, the door 3 and/or the cockpit 4 may exhibit the spring-back effect as the door 3 and/or the cockpit 4 (including the skin layer 2 and/or the at least one resilient layer 17) returns to its original configuration after the door 3 and the cockpit 4 are no longer interfaced.

The at least one resilient support 17 may include a foam layer beneath the skin layer 2. As illustrated in FIGS. 2A-2B, the vehicle may include a carrier module 8 coupled to the door 3, and supporting the trim panel 7, such that the foam layer of the resilient support 17 is sandwiched between the carrier module 8 and the skin layer 2. The foam layer of the resilient support 17 may be connected to the carrier module 8 by way of a substrate 27. A thickness of the foam layer of the support 17 is sufficient to cause the skin layer 2 to contact and engage a substantial portion of the lateral side surface 11 of the cockpit 4 when the door 3 is closed. Compression of the foam layer of the support 17 and/or the skin layer 2 may occur by way of the carrier module 8 or trim panel 7 on one side, and the lateral side surface 11 of the cockpit 4 on the other side. The apparatus 1, the skin layer 2, the resilient support 17 (e.g., or other surface of the door 3) on the door 3 interfacing the cockpit 4 may have such compliance by design (e.g., due to the foam layer, an elastic material, etc.) to allow up to 6-8 mm of compression thickness into the surface of the door 3. As such, the thickness of the foam layer may be at least 6-8 mm. The thickness of the deformation region (e.g., the apparatus 1, the skin layer 2, the resilient support 17, etc.) of the door 3 may be sized such that the seam, without a gap, may be created between the door 3 and the cockpit 4 without bottoming out in the door 3. Alternatively or additionally, only up to thirty percent (30%) of the thickness of the surface of the door 3 may be compressed and/or deformed depending on the vehicle architecture. Alternatively or additionally, the at least one resilient support 17 may include additional resilient material, such as, but not limited to, a spring (e.g., a spring-coil bed or mattress), or the like.

The trim panel 7 may be considered to be a combination of the skin layer 2, the at least one resilient support 17, and/or the substrate 27.

The interface apparatus 1 may employ less expensive, fewer, or lightweight components, such as for, but not limited to, the flexibly resilient skin layer 2, the one or more resilient supports 17 (e.g., the foam layer of support 17), etc., which add to the aesthetic and spatial freedom of the vehicle interior. When the resilient support 17 is integrated into, connected to, molded to, etc. the door 3, the skin layer 2, and/or the cockpit 4, the door 3 and/or the cockpit 4 may be provided with an area that does not require a traditional substrate or back. As such, the inclusion of the resilient support 17 may reduce the weight/mass of the door 3 and/or the cockpit 4. The compliant or flexibly resilient skin layer 2 of the interface apparatus 1 may be made from any such material known to those skilled in the art, such as but not limited to, cloth fabric, vinyl, leather, suede, synthetics, etc.

In accordance with at least another embodiment of the invention as illustrated in FIGS. 3A-3B, the at least one resilient support 17 may include at least one recess 18 behind the skin layer 2, the at least one recess 18 being sized and shaped such that the engagement of the lateral side surface 11 of the cockpit 4 against the skin layer 2 causes the skin layer 2 to press and stretch into the at least one recess 18. The at least one recess 18 may be formed within a carrier module 8A beneath the skin layer 2 opposite the lateral side surface 11 of the cockpit 4 when the door 3 is closed. The at least one recess 18 may be sized, shaped, and/or located such that the at least one recess 18 is matched to contours of the surface 11 of the cockpit 4 when the door 3 is closed. For example, the at least one recess 18 may permit a portion (e.g., protrusion 10 as shown in FIGS. 3A and 3B, and as further discussed below) of the cockpit 4 therein, and/or substantially mate with the portion of the cockpit 4. The carrier module 8A may be coupled to the door 3 and may support a trim panel 7A. The compliant or flexibly resilient skin layer 2 may be stretched over the trim panel 7A, and the trim panel 7A may include one or more apertures in registration with the at least one recess 18 such that the skin layer 2 is stretchable, and may be pressed, into the at least one recess 18 (as best seen in FIG. 3B). Because the skin layer 2 may be connected to the carrier module 8A on all sides of the at least one recess 18, the portion of the skin layer 2 that covers the at least one recess 18 may exhibit a spring-back effect due to the resilience of the skin layer 2. As a secondary effect, the temporarily deformed skin layer 2 may push the cockpit 4 away as the driver and/or passenger opens the door 3. As such, the skin layer 2 may assist with the opening of the door 3 such that less force or energy is required from the driver and/or passenger than would normally be required without the use of the interface apparatus 1. Those skilled in the art will appreciate that the carrier module 8A may be modified to include the at least one void area or recess 18 such that the interface apparatus 1 may be located on and/or in the door 3 in the same or substantially the same location as illustrated with interface apparatus 1 in FIGS. 2A-2B.

Alternatively or additionally, the interface apparatus may further include a rigid element 15 to help create, increase, and/or preserve the resilience (e.g., the spring-back effect) of the skin layer 2 and/or the at least one resilient support 17. Because the rigid element 15 creates, increases, and/or preserves the resilience (e.g., via preserving tautness) of the skin layer 2, the skin layer 2 may return to its original configuration as shown in FIGS. 2B and 3B when a driver and/or passenger of the vehicle opens the door 3 away from the cockpit 4. As best seen in FIGS. 2A-3B, the rigid element 15 may be placed on, and may depress/tighten, a portion of the skin layer such that a surface of the rigid element 15 may be in alignment with the skin layer 2. Additionally or alternatively, the rigid element 15 may be substantially flush with the skin layer 2 (as best seen in FIGS. 2A-2B). As illustrated in FIGS. 2A-2B, the interface apparatus 1 may further include at least one rigid element 15 disposed over the skin layer 2 and in engagement with at least one of the carrier module 8 and the trim panel 7, such that the at least one rigid element 15 presses the skin layer 2 into the foam layer of the support 17, and the skin layer 2 remains taut in a region of the door to cockpit interface apparatus 1. While the skin layer 2 remains taut, the spring-back effect of the skin layer 2 remains effective. Additionally, the skin layer 2 remains aesthetically appealing and preserves the integrated appearance in the door 3 while the skin layer 2 remains taut.

As illustrated in FIGS. 3A-3B, the interface apparatus may further include at least one rigid element 15 disposed over the skin layer 2 and in engagement with at least one of the carrier module 8A and the trim panel 7A, such that the at least one rigid element 15 presses the skin layer 2 at least toward the carrier module 8A, and the skin layer 2 remains taut in a region of the door to cockpit interface apparatus 1. When the carrier module 8A includes the at least one recess 18, the at least one recess 18 may be disposed on one or more sides of the rigid element 15. Additionally or alternatively, the at least one recess 18 may completely surround the rigid element 15 (e.g., in substantially an O-shape, where the rigid element 15 is located in the middle thereof). The rigid element 15 may be located on a portion of the carrier module 8A such that (i) a region of the skin layer 2 is located between the rigid element 15 and the portion of the carrier module 8A; and (ii) the rigid element 15 is substantially adjacent to a top portion 38 of a side wall 39 of the at least one recess 18 (as best seen in FIGS. 3A-3B).

The at least one rigid element 15 may be connected to the carrier module 8 and/or to the carrier module 8A (e.g., via a connection through the skin layer 2 and the at least one resilient support 17 as seen in FIGS. 2A-2B, via a connection through the skin layer 2 as seen in FIGS. 3A-3B, etc.) to remain stationary while the skin layer 2 and/or the at least one resilient support 17 is compressed. Those skilled in the art will appreciate that the rigid element 15 may be made from any rigid material, such as, but not limited to, wood, metal, polymers, etc., and may be connected to the carrier modules 8 and 8A in a variety of ways, such as, but not limited to, molding, gluing, bolting/screwing (as illustrated with the dashed lines in FIGS. 2A-3B), clamping, pressing, etc.

To keep the skin layer 2 and/or the at least one resilient support 17 taut, the rigid element 15 does not compress or become temporarily deformed when the skin layer 2 and/or the at least one resilient support 17 is compressed between the door 3 and the cockpit 4. As such, the lateral side surface 11 of the cockpit 4 (or alternatively the door 3 when the apparatus 1 is integrated into the cockpit 4) may include a relief groove or recess 12 (as illustrated in FIGS. 2A-3B) to receive the rigid element 15. Such a relief groove or recess 12 may be sized and shaped to receive the rigid element 15 such that the door 3 and the cockpit 4 are not deformed and/or damaged by the rigid element 15 when the door 3 is interfaced with the cockpit 4 (i.e., when the door 3 is closed). Such a relief groove or recess 12 may be positioned correspondingly to the rigid element 15, and may permit any protrusion 10 (further discussed below) of the cockpit 4 to temporarily deform or compress a portion of the skin layer 2 and/or the at least one resilient support 17 that is not covered by the rigid element 15 (e.g., the recess 12 may be positioned in between the at least one protrusion 10, in a portion of the surface area of the cockpit 4 where the protrusion(s) 10 is not located, etc.).

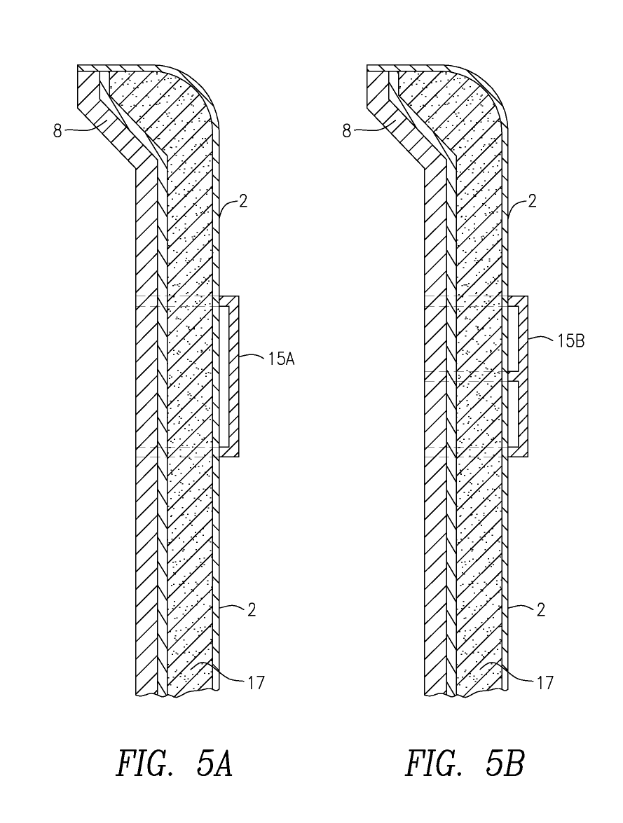

Alternatively, as only at least one point of connection/contact (rather than an entire side of the rigid element 15 as shown in FIGS. 2A-3B) may be needed to keep the rigid element 15 stationary, alternate embodiments of the rigid element 15 may be employed. For example, as seen in FIGS. 5A-5B, the rigid elements 15A and 15B may be used such that at least one portion of the rigid elements 15A and 15B is not directly disposed on the skin layer 2 and/or the at least one resilient support 17. Rigid elements 15A and 15B may be connected to the carrier modules 8 and 8A and/or to the trim panels 7 and 7A as similarly aforementioned for the rigid element 15 as shown in FIGS. 2A-3B.

Alternatively or additionally, the interface apparatus 1 may “temporarily deform” during the compression as a function of a size and shape of a portion of the cockpit 4 that is pressed against the skin layer 2 and/or the at least one resilient support 17 of the apparatus 1 (e.g., when the skin layer 2 and the at least one resilient support 17 are disposed on and/or in the door 3). The portion (e.g., one or more protrusion(s) 10 as best seen in FIGS. 2A-3B) of the cockpit 4 that presses against the skin layer 2 and/or the at least one resilient support 17 during the deformation may temporarily deform the interface apparatus 1 to create the appearance of a temporary deformation or depression 6 in the skin layer 2 and/or the at least one resilient support 17 such that the skin layer 2 and/or the at least one resilient support 17 substantially mates with the portion (e.g., the protrusion 10) of the cockpit 4. For example, when the skin layer 2 and the at least one resilient support 17 are disposed on and/or in the door 3, the at least one protrusion 10 of the cockpit 4 may temporarily deform/depress the interface apparatus 1 towards the trim panels 7 and 7A and/or carrier modules 8 and 8A of the door 3 (as best seen in FIGS. 2B and 3B, the cross-section taken from line 2B-2B of FIG. 1B). As best seen in FIGS. 2B and 3B, a portion of the skin layer 2 and/or a portion of the at least one resilient support 17 may not deform during compression when the door 3 and the cockpit 4 are interfaced.

Alternatively or additionally, as seen in FIG. 3B, when the at least one resilient support 17 includes the at least one recess 18, the at least one protrusion 10 of the cockpit 4 may temporarily deform or compress one or more portions of the skin layer 2 into the void area or recess 18 of the carrier module 8A. The interface apparatus 1 may appear substantially flat when the door 3 and the cockpit 4 are not interfaced, the cross-section taken from line 2A-2A of FIG. 1A. When the door 3 and the cockpit 4 are interfaced, the cockpit 4 may substantially mate with the skin layer 2 (as illustrated in FIG. 3B, the cross-section taken from line 2B-2B of FIG. 1B).

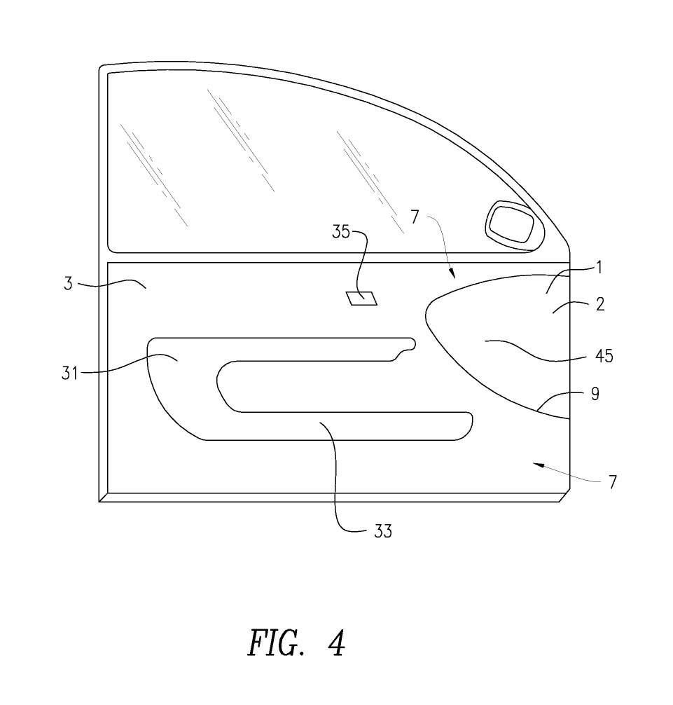

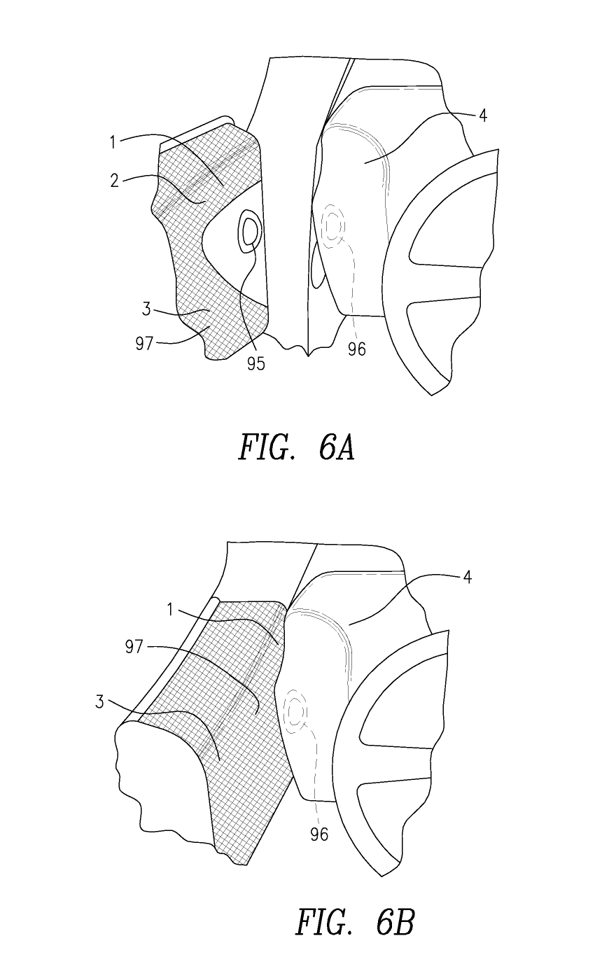

A predetermined surface area of compression 45 (best seen in the side view of the door 3 as illustrated FIG. 4) of the apparatus 1 may be substantially equal to a surface area of contact between the cockpit 4 and the interface apparatus 1. The predetermined surface area of compression 45 may vary in size and shape. The predetermined surface area of compression may include a surface area of the interface apparatus 1 and/or a surface area of the door 3 that is in contact with the cockpit 4 when the door 3 and the cockpit 4 are interfaced. Alternatively, the predetermined surface area of compression 45 of the apparatus 1 may be smaller or larger than a surface area of contact between the cockpit 4 and the interface apparatus 1 depending on the aesthetic and structural plans implemented in the vehicle. Additionally or alternatively, depending on the size and shape of the mating surfaces of the door 3 and the cockpit 4, the interface apparatus 1 may include one or more portions located away from the border of the predetermined surface area of compression 45 that may not compress between the interfaced door 3 and cockpit 4 (e.g., a portion of the skin layer 2, a portion of the foam layer of resilient support 17, and/or an area of the at least one recess 18 may be located outside of the area of compression 45). The “temporary deformation” or compression effect may occur without interfering with a driver's or passenger's ability to use an armrest 31 on the door 3, a bin 33 on the door 3, a door handle 35 of the door as illustrated in FIG. 4, or additional components of the vehicle (e.g., a steering wheel as seen in FIGS. 1A, 1B, 6A, and 6B).

Depending on the desired shape and aesthetics of the door 3 and/or the cockpit 4, the dimensions of the interface apparatus 1, the door 3, and/or the cockpit 4 may be altered accordingly. For example, the size, shape, etc. of the skin layer 2 and/or the at least one resilient support 17 of the interface apparatus 1 may be adjusted to suit particular configurations of the cockpit 4 (or the door 3 when the interface apparatus 1 is connected to the cockpit 4). The skin layer 2 and/or the at least one resilient support 17 may be sized and shaped such that at least one dimension (e.g., thickness, length, etc.): covers a portion, in part or in whole, of the door 3 and/or the cockpit 4; corresponds to the predetermined surface area of compression 45; is larger than the predetermined surface area of compression 45; is smaller than the predetermined surface area of compression 45; etc. such that a portion of the interface apparatus 1 does not deform during compression (as best seen in FIG. 2B), etc.

Now referring to FIGS. 6A-6B, the door to cockpit interface apparatus 1 as discussed above may aid in cockpit/IP 4 to door 3 air transfer(s). The vehicle may include a first port 95 through a portion of the skin layer 2 and the at least one resilient support 17 operating to transfer air therethrough; and a second port 96 through a portion of the lateral side 11 of the cockpit 4 and in fluid communication with the first port 95 when the door 3 is closed. Because the ports 95 and 96 are in fluid communication when the door 3 is closed, the interface apparatus 1 may provide a substantially air tight passage between the door and the cockpit/IP 4. The second port 96 may operate to transfer air from a source to the first port 95, and the first port may operate to transfer the air through the door 3. The vehicle may further include at least one rigid element 15 disposed over the skin layer 2 and in engagement with a rigid portion of the door 3, such that the at least one rigid element 15 presses the skin layer 2 at least toward the carrier module 8, and the skin layer 2 remains taut in a region of the door to cockpit interface apparatus 1 such that the first port 95 extends through the at least one rigid element 15 and through the portion of the skin layer 2 and the at least one resilient support 17. The vehicle may further include one or more apertures 97 in communication with the first port 95 and extending through the skin layer 2 of the door 3 (e.g., along a length of the door 3) such that the air transferred from the cockpit 4 to the door 3 via the first and second ports 95 and 96 emits from the door 3 to an interior of the vehicle. Such a configuration utilizes the limited space in the vehicle for providing air to the driver and/or passengers. The one or more apertures 97 may include, but are not limited to, perforations, laser-etched holes, recesses, vents, etc. Such apertures 95, 96, and 97 may be exposed; covered with grills; and/or covered with a porous fabric to permit air flow into the interior of the vehicle. The apertures 95, 96, and 97 may be included on/in the carrier module 8 and the trim panel 7, and/or on the carrier module 8A and the trim panel 7A. Alternatively or additionally, the apertures 95, 96, and 97 may be employed with the at least one rigid element 15 disposed on the carrier module 8 and the trim panel 7, and/or on the carrier module 8A and the trim panel 7A.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A vehicle, comprising:
a cockpit including at least one lateral side surface directed toward a door opening of the vehicle;
a door disposed in hinged relationship with respect to the door opening;
a trim panel coupled to the door and directed toward an interior of the vehicle when the door is in a closed position; and
a door to cockpit interface apparatus located on at least a portion of the trim panel and operating to engage and compress against the lateral side surface of the cockpit when the door is in the closed position, such that a seam, without a gap, is formed between the portion of the trim panel and the lateral side surface of the cockpit.

2. The vehicle according to claim 1, wherein the door to cockpit interface apparatus operates to substantially return to its original configuration when not compressed between the portion of the trim panel and the lateral side surface.

3. The vehicle according to claim 1, wherein the door to cockpit interface apparatus includes:
a skin layer disposed on the trim panel and directed toward an interior of the vehicle, such that the skin layer engages and compress against the lateral side surface of the cockpit when the door is in the closed position; and
at least one resilient support disposed under the skin layer and operating to provide compressibility of the skin layer opposite the lateral side surface of the cockpit.

4. The vehicle according to claim 3, wherein the at least one resilient support is sized and shaped to correspond with a predetermined surface area of compression between the skin layer and the lateral side surface of the cockpit.

5. The vehicle according to claim 3, wherein the at least one resilient support is sized and shaped larger than a predetermined surface area of compression between the skin layer and the lateral side surface of the cockpit, such that a portion of the at least one resilient support does not deform during compression when the door is closed.

6. The vehicle according to claim 3, wherein at least one of:
the at least one resilient support comprises a foam layer beneath the skin layer; and
the skin layer is formed from at least one of: cloth fabric, vinyl, leather, suede, and synthetics.

7. The vehicle according to claim 6, further comprising:
a carrier module coupled to the door and supporting the trim panel, such that the foam layer is sandwiched between the carrier module and the skin layer,
wherein a thickness of the foam layer is sufficient to cause the skin layer to contact and engage a substantial portion of the lateral side surface of the cockpit when the door is closed.

8. The vehicle according to claim 7, wherein compression of the foam layer occurs by way of the carrier module or trim panel on one side, and the lateral side surface of the cockpit on the other side.

9. The vehicle according to claim 7, wherein the thickness of the foam layer is at least 6-8 mm.

10. The vehicle according to claim 7, further comprising at least one rigid element disposed over the skin layer and in engagement with at least one of the carrier module and the trim panel, such that the at least one rigid element presses the skin layer into the foam layer, and the skin layer remains taut in a region of the door to cockpit interface apparatus.

11. The vehicle according to claim 10, further comprising at least one relief recess positioned within the lateral side surface of the cockpit, and sized and shaped to receive the at least one rigid element when the door is in the closed position.

12. The vehicle according to claim 3, wherein the at least one resilient support comprises at least one recess behind the skin layer, the at least one recess being sized and shaped such that the engagement of the lateral side surface of the cockpit against the skin layer causes the skin layer to press and stretch into the at least one recess.

13. The vehicle according to claim 12, further comprising:
a carrier module coupled to the door and supporting the trim panel,
wherein the at least one recess is formed within the carrier module beneath the skin layer opposite the lateral side surface of the cockpit when the door is closed.

14. The vehicle according to claim 13, wherein:
the skin layer is stretched over the trim panel; and
the trim panel includes one or more apertures in registration with the at least one recess such that the skin layer is stretchable, and may be pressed, into the at least one recess.

15. The vehicle according to claim 13, further comprising at least one rigid element disposed over the skin layer and in engagement with at least one of the carrier module and the trim panel, such that the at least one rigid element presses the skin layer at least toward the carrier module, and the skin layer remains taut in a region of the door to cockpit interface apparatus.

16. The vehicle according to claim 15, further comprising at least one relief recess positioned within the lateral side surface of the cockpit, and sized and shaped to receive the at least one rigid element when the door is in the closed position.

17. The vehicle according to claim 3, further comprising:
a first port through a portion of the skin layer and the at least one resilient support operating to transfer air therethrough; and
a second port through a portion of the lateral side of the cockpit and in fluid communication with the first port when the door is closed,
wherein the second port operates to transfer air from a source to the first port and the first port operates to transfer the air through the door.

18. The vehicle according to claim 17, further comprising:
at least one rigid element disposed over the skin layer and in engagement with a rigid portion of the door, such that the at least one rigid element presses the skin layer at least toward the carrier module, and the skin layer remains taut in a region of the door to cockpit interface apparatus,
wherein the first port extends through the at least one rigid element and through the portion of the skin layer and the at least one resilient support.

19. The vehicle according to claim 17, further comprising one or more apertures in communication with the first port and extending through the skin layer of the door such that the air transferred from the cockpit to the door via the first and second ports emits from the door to an interior of a vehicle.

20. The vehicle according to claim 19, wherein the one or more apertures comprise at least one of: perforations, laser-etched holes, recesses, and vents.
